(19) United States
(12) Patent Application Publication
(10) Pub. No.: US 2007/0267616 A1
(43) Pub. Date: Nov. 22, 2007

(54) Method of manufacturing a decorative fencing system

(76) Inventor: Duane Langenwalter, Monroe, CT (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/797,991

(22) Filed: May 9, 2007

Related U.S. Application Data
(63) Continuation-in-part of application No. 10/797,410, filed on Mar. 10, 2004.

(51) Int. Cl. E04H 17/00; B23P 17/00

(52) U.S. Cl. 256/21; 29/592

(57) ABSTRACT

A method of manufacturing a decorative fencing system for use as a small fence or decorative accent fence for a yard or garden. The fencing system comprises several different structural components that may be joined in various combinations so as to create a nearly limitless number of different configurations or arrangements. The components include base units, decorative end units and gate units, each of which may be attached to the other components in any combination thereof. Each of these components are attached to post sections which are removably and interchangeably inserted through post rings or post hinges or welded onto the individual components to thereby allow for each component to be rotated to the desired position relative to the post section. The post sections are removably and interchangeably secured to the ground by means of stakes that are driven into the ground and the post section is then inserted into a sleeve in the stake, or alternately onto a post-receiving extension on the stake to thereby provide support and stability for the fencing system, with the post section being held by the stake, either removably or permanently.

This is a continuation-in-part of U.S. patent application Ser. No. 10/797,410, filed Mar. 10, 2004, which is currently pending, the contents of which are incorporated herein by reference.

### BACKGROUND OF THE INVENTION

1. Field of the Invention

The present invention relates generally to a method of manufacturing a decorative fencing system, and, more particularly, to a method of manufacturing a decorative fencing system that includes multiple components and may be arranged in a potentially unlimited number of combinations and permutations, to be used as a small or low fence, or a decorative accent fence for an outdoor yard or walk, or a combination thereof.

2. Description of the Related Art

The art fails to specifically address either the problem or the solution reached by the applicant. Decorative fencing systems have long been known in the industry, as has the use of sectional fence structures to create various configurations for fencing systems. Some examples of such fencing systems are shown in references that date back to the mid to late 1800s.

A common shortcoming in the related art is inflexibility. In many systems, the fence can be assembled by the user in only a single configuration. In other systems, while more than one configuration is possible, it is complicated and time consuming for the user, after assembling the fence in one configuration, to disassemble it and reassemble it in another configuration.

There has long been a need for a decorative fencing system, which can be easily and quickly assembled in one configuration, easily and quickly disassembled, then easily and quickly reassembled in any one of a nearly limitless variety of different configurations.

### SUMMARY OF THE INVENTION

The present invention relates to a method of manufacturing a decorative fencing system having several components that may easily and quickly be arranged in one of a nearly limitless number of configurations or combinations, easily and quickly disassembled, and easily and quickly reassembled in another one of the nearly limitless number of configurations or combinations.

The present invention provides a method of manufacturing such a decorative fencing system that may be used as a small or low fence, or a decorative accent fence for an outdoor yard or walk, or even a combination thereof.

The present invention further provides a method of manufacturing such a decorative fencing system that allows a user to purchase and use only those elements necessary to create the design or shape of his or her choosing.

The present invention further provides a method of manufacturing such a decorative fencing system that may be either permanently or temporarily affixed to the ground.

The present invention further provides a method of manufacturing such a decorative fencing system which includes all the elements necessary to create a standard fence, including base units, gates and end units.

The present invention further provides a method of manufacturing such a decorative fencing system which may include a variety of interchangeable, structural, functional, and decorative elements.

The present invention further provides a method of manufacturing such a decorative fencing system in which the individual components are manufactured from a variety of materials or be provided with a variety of finishes.

The present invention, as broadly disclosed herein, comprises a method of manufacturing a decorative fencing system, designed to be used as a small fence or decorative accent fence for an outdoor yard, or a combination thereof. The fencing system is manufactured to include several different components that may be joined in various combinations so as to create a limitless number of different configurations or arrangements. The components include base units, decorative end units and gate units, each of which may be removably and interchangeably attached to the other components in any combination thereof. Each of these components are removably and interchangeably attached to post sections which are inserted through post rings or post hinges on the individual components to thereby allow for each component to be rotated to the desired position relative to the post section. The post sections can be removably and interchangeably secured to the ground by means of stakes that are first driven into the ground.

In one embodiment, the post sections are removably and interchangeably insertable into respective sleeves in the stakes, to thereby provide support and stability for the fencing system. The fence components are removably and interchangeably attachable to selected post sections to create a desired fence configuration.

In another embodiment, the post sections are manufactured to be friction-fit to the stakes, the stakes driven into the ground, and the fence components are then removably and interchangeably attached to selected post sections, in order to create a desired fence configuration.

In still another embodiment, a lower portion of the posts are manufactured to be hollow, and the stakes are configured with a protruding extension. The hollow lower portions of the posts are removably and interchangeably insertable over a respective protruding portion of selected stakes, and the fence components are removably attachable to selected post sections to interchangeably create a desired fence configuration.

### BRIEF DESCRIPTION OF THE DRAWINGS

The objects and advantages of the present invention will be apparent from the detailed explanation of the preferred embodiments of the invention in connection with the accompanying drawings, wherein:

FIG. 1 is a front elevational view of a portion of the decorative fencing system of the present invention showing various components thereof.

FIG. 1A is a top view of a post ring attached to a structural fencing portion in FIG. 1.

FIG. 2 is an exploded side view of one embodiment of a post and stake of the present invention, wherein a diameter of a removable post is smaller than an internal diameter of a stake sleeve.

FIG. 2A is an exploded side view of another embodiment of a post and stake of the present invention, where an internal diameter of a removable post is substantially identical to an internal diameter of a stake sleeve.

FIG. 3 is an exploded side view of one embodiment of a post and stake of the present invention, wherein an internal diameter of a removable post is larger than a diameter of a post receiving extension on the stake.

FIG. 4 is a front elevational view of a fence base unit.

FIG. 5 is a front elevational view of a fence end unit.

FIG. 5A is a front elevational view of another embodiment of a fence end unit.

FIG. 6 is a front elevational view of fence gate units.

FIG. 7 is a front view of a decorative fence system in accordance with the invention.

FIG. 8 is a top perspective view depicting different arrangements of the decorative fence system of the invention.

### DETAILED DESCRIPTION OF THE INVENTION

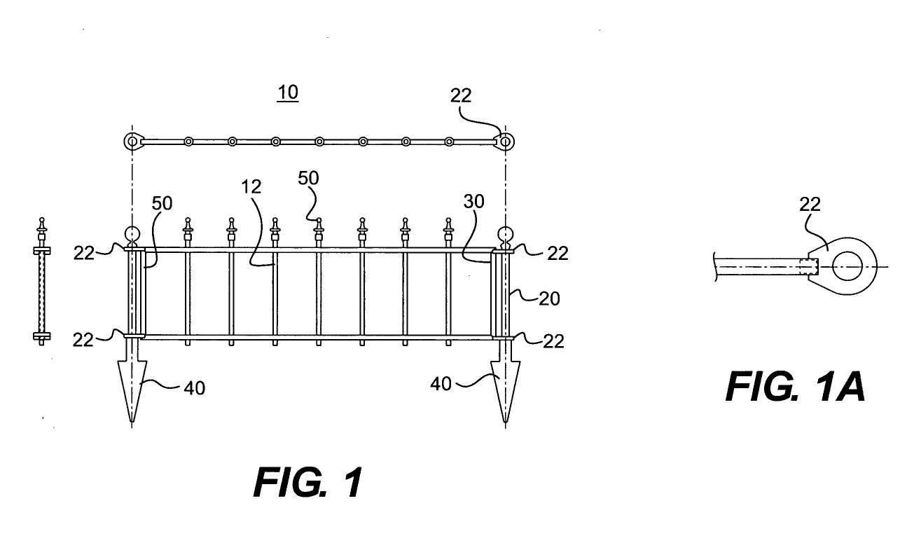

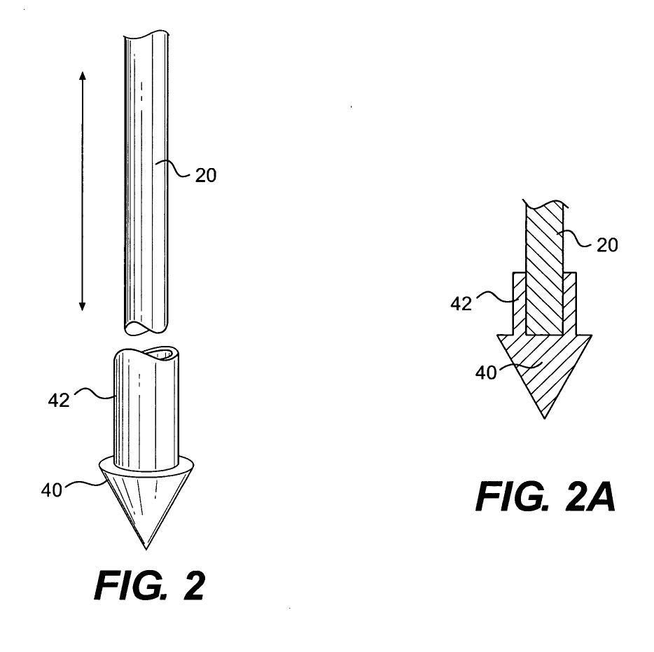

Referring to the drawings and, in particular, to FIGS. 1, 1A, and 2, the decorative fencing system of the present invention, referred to generally by reference numeral 10, is illustrated. The fencing system 10 comprises separate structural components 12 including a base unit 14, a gate unit 16, and an end unit 18, which are arranged and combined with each other so as to create a potentially limitless number of configurations for the decorative fencing system 10.

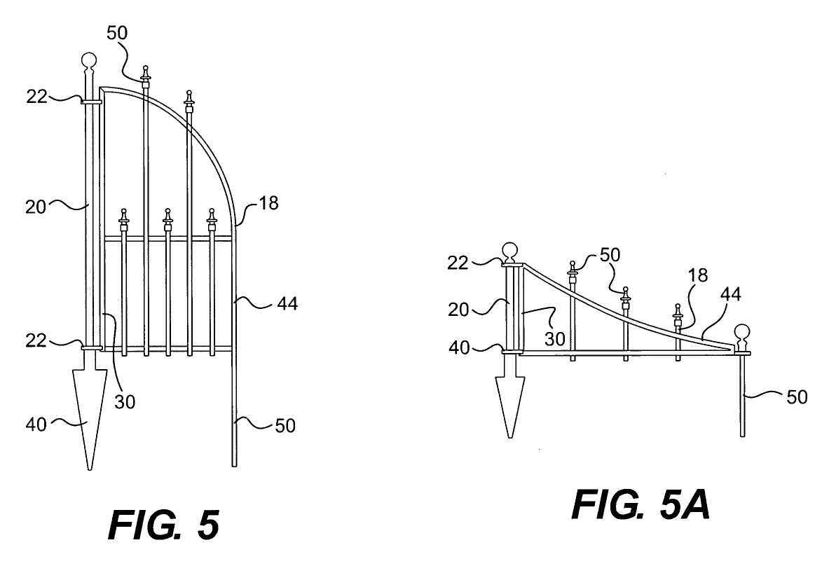

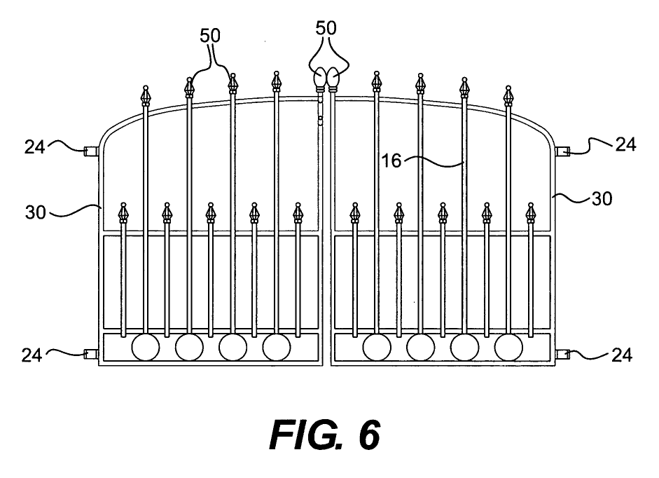

The fence structural components 12 are manufactured to be attached to each other by means of one or more posts 20 to which the fence structural components 12 may be removably and interchangeably attached. In the preferred embodiment, the means for attaching the fence structural components 12 comprises post rings 22, depicted in FIGS. 1 and 1A, which are disposed on either end of the base units 14 or on one end of the end units 18, shown in FIG. 5, or by post hinges 24, which are disposed on the outside edges of the gate units 16 shown in FIG. 6. The post rings 22 are annular elements having an inner diameter slightly larger than the diameter or width of the posts 20 such that post 20 may be slidably inserted within the post rings 22 to thereby engage either the base unit 14 or end unit 18. As broadly embodied herein, the inner diameter of the post rings 22 is approximately 21 mm and the diameter of the posts 20 is approximately 19.76 mm. Similarly the post hinges 24, include annular elements similar to the post rings 22 coupled with a hinge 26, that allows the individual gate elements 28 of the gate unit 16 to swing open and shut. In the preferred embodiment, the gate elements 16 comprise a pair of complementary doors that may be operated independently or concurrently, although other designs are possible so as to fit with the design and theme of the decorative fencing system 10.

As illustrated in FIGS. 1 and 4-6, each of the structural components 12 includes two post rings 22 or post hinges 24 at each end at which the component 12 may be attached to the post 20. For example, the base unit 14 includes two post rings 22 on either side thereof, the gate unit 16 includes two post hinges 24 on the outside edge of each gate element 28, and the end unit 18 includes two post rings 22 on one side thereof. In the preferred embodiment, the post rings 22 or post hinges 24 are attachable to a substantially vertical element 30 so that the post rings 22 or post hinges 24 are in alignment when receiving the posts 20. Alternate embodiments are possible in which either the post rings 22 or post hinges 24 are attachable to horizontal components or other elements provided, however, that the post rings 22 or post hinges 24 are in alignment. Furthermore, while in the preferred embodiment only two post rings 22 or post hinges 24 are disposed along each vertical element 30, more may be provided so as to further strengthen and secure the attachment of the structural components 12 to the posts 20.

It should also be appreciated that while in the preferred embodiment, the post rings 22 and post hinges 24 are disposed at the top and the bottom of the vertical elements 30, as shown in FIGS. 1 and 4-6, they may be positioned at various heights along the length of the vertical elements 30 as may be desired. For example, as illustrated in FIGS. 1 and 4-6, the height of the upper post ring 32 on the base unit 14 is higher than that of the upper post ring 22 on the end unit 18, which, in turn, is higher than upper post hinge 24 on the gate unit 16. This configuration facilitates the combination of two or more structural components 12 since the post rings 22 or post hinges 24 will not necessarily interfere with each other. It should also be appreciated that, in the preferred embodiment, contact should be avoided between the post hinges 24 and the post rings 22 so as to prevent interference with the operation of the hinges. Toward that end, it may be preferred to mount the lower post hinges 24 of the gate unit 16 as broadly depicted in FIG. 6, above the lower post rings 22 of either the base unit 14 or the end unit 18.

The decorative fencing system 10 is secured to the ground by means of one or more stakes 40. The stakes 40 are designed to be driven into the ground and receive the posts 20 to thereby support the structural components 12 in place. In the preferred embodiment, the stakes 40 are manufactured to be wedge shaped or to include a plurality of fins so as to facilitate their insertion into the ground, although a variety of alternative designs are possible. Preferably, the stakes 40 are pointed at one end, so that the stakes can be forcibly driven into the ground. However, if the user prefers to dig a hole for the stakes 40, this can be done, and these elements could be of practically any shape or size, provided they could receive and retain the posts 20.

In one preferred embodiment, as broadly depicted in FIG. 2, the stakes 40 receive and retain the posts 20 by means of a stake sleeve 42, essentially a cylindrical recess or cavity within the body of the stake 40 having an internal diameter slightly larger than the diameter or width of the post 20 such that the post 20 will be received within and retained by the stake sleeve 42 only by means of frictional contact therebetween. The posts 20 preferably are manufactured to be removably held only by friction, so that they are removable from each stake sleeve 42 and insertable into another stake sleeve 42, as desired. They are not welded or otherwise permanently affixed in place. As broadly embodied herein, in this embodiment the preferred internal diameter of the stake sleeves 42 is approximately 22 cm-22.5 cm, and the preferred external diameter is approximately 26.5-28 cm. There is some clearance between the post 20 and the internal surface of the stake sleeve 42. In this embodiment, post 20 can be removed from stake 40, leaving stake 40 in the ground, and reinserted into another stake 40 driven into the ground at a different selected location.

Alternatively, in another preferred embodiment, as broadly depicted in FIG. 2A, the posts are made larger, so that the diameter of the posts 20 are substantially identical to an internal diameter of the stake sleeve 42. In this embodiment, the posts 20 are permanently friction-fit into the stake sleeves 42. In this embodiment, removal of post 20 from the ground for movement to another selected location, also requires removal of the stake 40 from the ground.

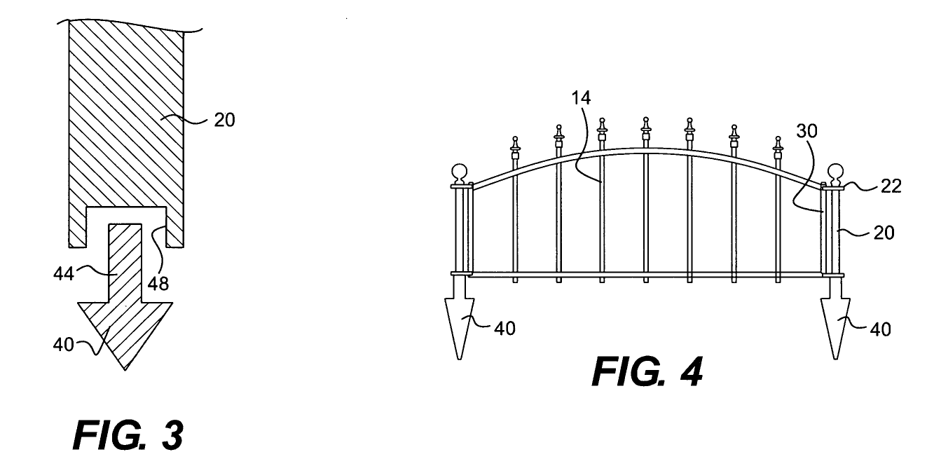

In another preferred embodiment, as depicted broadly in FIG. 3, stake 40 is manufactured with an extending solid post-receiving portion 44, and the post 20 has a hollow portion 48 at its lower distal end, with a diameter larger than the diameter of the post receiving portion 44. In this embodiment, each selected post hollow portion 48 fits over each selected post-receiving portion 44, and the posts 20 are supported thereby. In this embodiment, like the embodiment of FIG. 2, post 20 can be removed from stake 40, without removing stake 40 from the ground, and moved to another stake 40, which is driven into the ground at a different location.

Ideally, the stake sleeve 42 or post-receiving portion 44 should be of sufficient length so as to securely receive the post 20, and the length of the portion of the stake 40 that is inserted into the ground, or the length of post hollow portion 48 that sits on top of post-receiving portion 44 should be sufficient to prevent the post 20 from toppling over when the decorative fencing system 10 is assembled. In a preferred embodiment, the length of the portion of the stake 40 that is inserted into the ground, or that sits on top of post-receiving portion 44 is approximately 10 cm, although longer stakes 40 may function just as well, and shorter ones may also serve effectively, provided the weight of the structural components and posts 20 are not too great, and the ground itself is firm enough to retain the stake 40 therein. Also in the preferred embodiment, the stake sleeve 42 should extend above the ground level by a sufficient height to allow the desired clearance between the bottom of the structural components 12 and the ground. As broadly embodied herein, a preferred height of the stake sleeves 42 is approximately 15-20 cm, with a height above the ground of approximately 5 cm-8 cm. This is most significant for the gate unit 16, since the gate elements must clear any uneven ground in order to allow the gate elements to open and close properly. Furthermore, the combined weight of the post 20 and any structural components 12 attached thereto serve to force the post 20 within the stake sleeve 42 and prevent the post from sliding out prematurely.

The end units 18, broadly depicted in FIGS. 5 and 5A, serve to provide decorative termination points for the decorative fencing system 10, and as such, include a decorative termination point 44 on the side opposite the vertical element 30 or the side to which the post rings 22 are attached. Rather than use a separate post 20 to anchor the termination point 44 to the ground, a separate stake pin 50 can be provided at the termination point 44. The stake pin 50 extends below ground level when the end unit 18 is attached, thereby securing the end of the end unit 18 to the ground. As illustrated in FIGS. 5 and 5A, in preferred embodiments the stake pin 50 can be thin to facilitate its insertion into the ground. It also is of approximately the same length as the stake 40, although a shorter stake pin 50 would work just as effectively.

In the preferred embodiment of the method of manufacturing fencing system 10, the components of fencing system 10 are manufactured from tubular steel, and both square and round stock. A powder coat finish may be provided on some or all of the elements. For example, a separate color or finish or a different material, such as bronze colored cast iron, may be used for decorative accents 48 such as finials 51 or decorative ball caps 52.

Preferably, jigs are set up and all of the component pieces are cut from tubular steel, wire rod, and flat stock, i.e., the stakes 40, the posts 20, structural components 12, post rings 22, post hinges 24, and so on.

Curved pieces are then formed at appropriate locations in the end structural components 12, and some structural components 12 are shaped into end units 18 or gate units 16.

The post rings 22 are cut, and stamped into their final shape.

Holding the components in jigs, decorative finials 50 may be welded into ends of the posts 20 or vertical pieces of structural components 12, and hinges 24 are welded into place on gate units 16. Rings 22 are also welded into appropriate locations on structural components 12.

The components are prepared for powder coating either through insertion into a metal pellet sand blast chamber or through the use of an acid wash sequence that ends with drying to eliminate water in the crevices prior to coating.

Individual pieces are then powder coated.

Alternative manufacturing methods, or minor variations on the above method, are also contemplated, including manufacturing individual components out of solid iron or steel pieces, then welding and then finishing by powder coating or painting. The components may be produced as individual cast iron pieces and finished with various paint techniques to create different appearances.

It should be appreciated that the design of the individual structural components shown in the drawings represent one possible design for the decorative fencing system 10 of the present invention. A variety of different designs and decorative accents 48 are contemplated, such as a Victorian design or a more modern design. The only limitation is that the design of the system 10 is embodied by the structural components 12 and tied together by the posts 20, post rings 22 and post hinges 24, and that the structural components 12 and posts 20 are removable and interchangeable so that a wide variety of fence configurations can be assembled, as explained below.

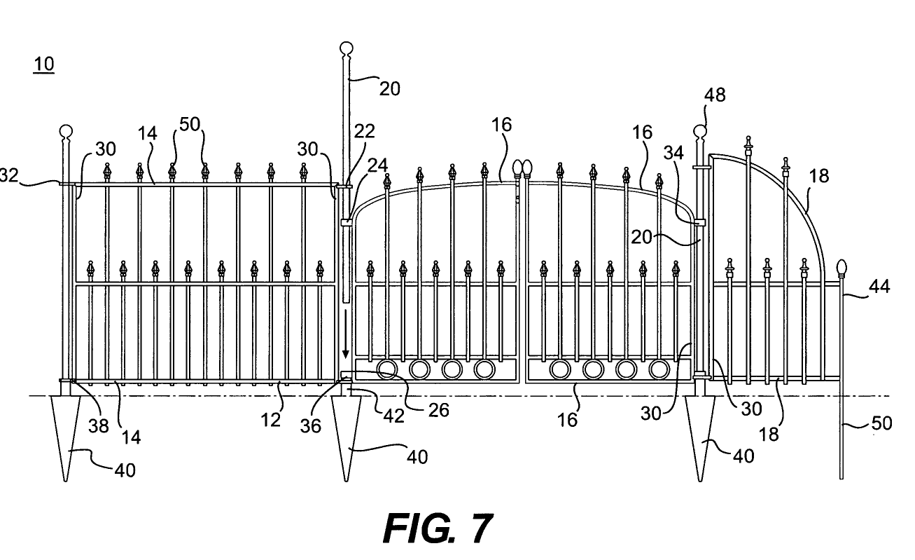

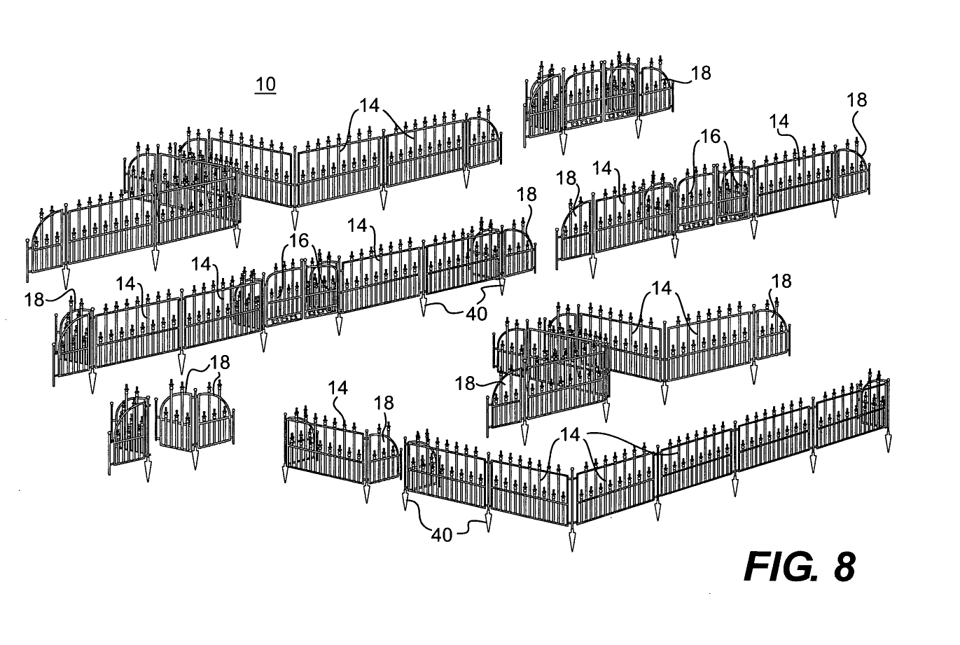

The process of assembling the fencing system 10 is designed to be simple and easy to alter. In the preferred embodiment, a stake 40 is driven into the ground, and the individual structural components 12 are held into place above the stake 40. A post 20 is inserted through the post rings 22 and/or post hinges 24, are then removably inserted into the stake sleeve 42 of the stake 40, or in another embodiment friction-fit into the stake sleeve. The process is repeated as necessary until the desired configuration is achieved, allowing for a potentially infinite number of combinations and angles between the structural components. Some examples of these variations are illustrated in FIGS. 7 and 8. Since each of the structural components 12 may be purchased separately, the decorative fencing system 10 may be as large or as small as the user.

Having thus described the invention with particular reference to the preferred forms thereof, it will be obvious that various changes and modifications can be made therein without departing from the spirit and scope of the present invention as defined by the appended claims.

What is claimed is:

1. A method of manufacturing a decorative fencing system comprising the steps of:
cutting from a first material a plurality of stakes, configured to be driven into the ground, each said stake including a hollow stake sleeve having a first diameter;
cutting from a second material a plurality of posts, each said post having a second diameter smaller than said first diameter, each said post configured to be inserted into one of said plurality of stake sleeves, and to be held therein;
forming from the second material and a third material a plurality of structural fencing components, each fencing component having horizontal components, vertical components, and a vertical end piece; and
fixing to each said end piece an annular ring, each said annular ring having a third diameter larger than said second diameter, each said annular ring configured to be removably and interchangeably inserted onto one of said plurality of posts.

2. The method of manufacturing a decorative fence system according to claim 1, wherein each said post is cut and shaped to be removably and interchangeably inserted into at least one of said plurality of stake sleeves.

3. The method of manufacturing a decorative fencing system according to claim 1, further comprising the steps of:
cutting a hinge portion out of the first material; and
fixing said hinge portion to one of a post or an end piece of a structural fencing component.

4. The method of claim 1, further comprising a step of cutting and fixing decorative accents on selected ones of said vertical components of said structural fencing components, and selected ones of said posts.

5. The method of claim 1, wherein said posts are cut to be temporarily held in said stake sleeves.

6. The method of claim 1, wherein each said annular ring is welded to each said end piece.

7. The method of claim 2, wherein said hinge portion is welded to said one of said post or end piece.

8. The method of claim 1, wherein said first material is flat stock.

9. The method of claim 1, wherein said second material is pipe steel.

10. A method of manufacturing a decorative fencing system comprising the steps of:
cutting from a first material a plurality of posts, each post having a distal end defining a hollow portion having an internal diameter;
cutting from a second material a plurality of stakes, configured to be driven into the ground, each said stake including a pipe-receiving portion projecting from an upper flange portion, said pipe-receiving portion having a diameter small than the internal diameter of the hollow portion of the post;
forming from the second material and a third material a plurality of structural fencing components, each fencing component having horizontal components, vertical components, and a vertical end piece; and
fixing to each said end piece an annular ring, each said annular ring having a third diameter larger than said second diameter, each said annular ring configured to be removably and interchangeably inserted onto one of said plurality of posts.

11. The method of manufacturing a decorative fencing system according to claim 10, wherein each said post is cut and shaped to be removably and interchangeably inserted over at least one of said plurality of post-receiving portions extending from said stakes.

12. The method of manufacturing a decorative fencing system according to claim 10, further comprising the steps of:
cutting a hinge portion out of a first material; and
fixing said hinge portion to one of a post or an end piece of a structural fencing component.

13. The method of claim 10, further comprising a step of cutting and fixing decorative accents on selected ones of said vertical components of said structural fencing components, and selected ones of said posts.

14. The method of claim 10, wherein said posts are cut to be temporarily held on said stake sleeves.

15. The method of claim 10, wherein each said annular ring is welded to each said end piece.

16. The method of claim 11, wherein said hinge portion is welded to said one of said post or end piece.

17. The method of claim 10, wherein said first material is flat stock.

18. The method of claim 10, wherein said second material is pipe steel.

19. A method of manufacturing a decorative fencing system comprising the steps of:
cutting from a first material a plurality of stakes, configured to be driven into the ground;
cutting from a second material a plurality of posts, each said post configured to connect to one of said plurality of stakes;
forming a plurality of structural fencing components;
fixing to each fencing component an annular ring, configured to removably attach to one of said posts.

20. The method of claim 19, wherein said posts are cut to removably and interchangeably connect to one of said plurality of stakes.

21. The method of claim 19, wherein said posts are cut to be permanently friction fit into respective ones of said stakes.
